(19) United States
(12) Patent Application Publication
(10) Pub. No.: US 2012/0125987 A1
(43) Pub. Date: May 24, 2012

(54) FLATBREAD CONTAINER

(75) Inventors: James A. Hubbard, JR., Oak Lawn, IL (US); Lauren Mikos, Chicago, IL (US); Matthew R. Cook, Hinsdale, IL (US)

(73) Assignee: LBP Manufacturing, Inc., Cicero, IL (US)

(21) Appl. No.: 12/949,535

(22) Filed: Nov. 18, 2010

(51) Int. Cl. B65D 5/42; B31B 1/74; B31B 1/20

(52) U.S. Cl. 229/108; 229/198.2; 493/340; 493/162; 493/121

(57) ABSTRACT

A container is disclosed for packaging flatbread, a flatbread sandwich or other food item. The container is made from a single, flat piece of paperboard having four sides and a pair of perforated lines formed therein running between two first sides and generally in the middle of the paperboard. The perforated lines come together at end portions thereof to meet at edges of the first sides to facilitate folding the flat paperboard in half along the perforated lines to close the container around a food item placed therein. Scored lines are formed spaced from the first and second sides to facilitate folding to form end and top portions of the container. Diagonal slots may be formed in corners of the flat paperboard that define hook structures capable of mutual engagement for securing closed the second sides around the food item.

### BACKGROUND

In our increasingly fast-paced society, individuals are forced to eat on the run. People often purchase food and drinks from convenience stores, restaurants, and cafés which offer take out options. So-called fast food stores cater to such needs. Take out options are typically packaged in, for example, disposable cups, plates, trays, bags and clamshells. After consuming the food, the individual can quickly dispose of the food packaging in a trash receptacle.

Once assembled, the trays or clamshells are typically fairly deep and bulky and thus often waste space where the item being packaged is smaller than the volume of space defined within the tray or clamshell.

### BRIEF SUMMARY

A container is disclosed for packaging flatbread, a flatbread sandwich or other food item such as a wrap or a taco. The container is made from a single, flat piece of paperboard having four sides and a pair of perforated lines formed therein running between two first sides and generally in the middle of the paperboard. The perforated lines come together at end portions thereof to meet at edges of the first sides to facilitate folding the container in half along the perforated lines to close the container around a food item placed thereon. In some examples, more or less than a pair of perforated lines may be used.

Other systems, methods, features and advantages of the disclosure will be, or will become, apparent to one with skill in the art upon examination of the following figures and detailed description. It is intended that all such additional systems, methods, features and advantages be included within this description, be within the scope of the invention, and be protected by the following claims.

### BRIEF DESCRIPTION OF THE DRAWINGS

FIG. 1 is a side perspective view of an exemplary flatbread container, after full assembly with a food item therein.

FIG. 2 is a top perspective view of the flatbread container of FIG. 1.

FIG. 3 is a top, plan view of an exemplary paperboard flat blank before assembly into a flatbread container.

FIG. 4 is perspective view of the flat blank of FIG. 3 after gluing a pair of the corners of the flat blank.

FIG. 5 is a perspective view of the flat blank of FIG. 4 after gluing the other pair of corners of the flat blank of FIG. 3, thus creating a partially-assembled flatbread container.

FIG. 6 is the partially-assembled flatbread container of FIG. 5 lying flat and being employed in service of assembling a finished product such as a flatbread sandwich.

FIG. 7 is a nearly fully-assembled flatbread container where the partially-assembled container of FIG. 6 is squeezed shut with the food product therein.

FIG. 8 is a corner perspective view of the flatbread containers of FIGS. 1 and 2 after mutual engagement of hooks defined in corners of the flat blank of FIGS. 3-5.

### DETAILED DESCRIPTION

By way of introduction, the present disclosure relates to a container for packaging flatbread, a flatbread sandwich or other food item. The container is made from a single, flat piece of paperboard having four sides and a pair of perforated lines formed therein running between two first sides and generally in the middle of the paperboard. The perforated lines come together at end portions thereof to meet at edges of the first sides to facilitate folding the flat paperboard in half along the perforated lines to close the container around a food item placed therein. In some examples, more or less than a pair of perforated lines may be used. Scored lines are formed spaced from the first and second sides to facilitate folding to form end and top portions of the container. Diagonal slots may be formed in corners of the flat paperboard that define hook structures capable of mutual engagement for securing closed the second sides around the food item.

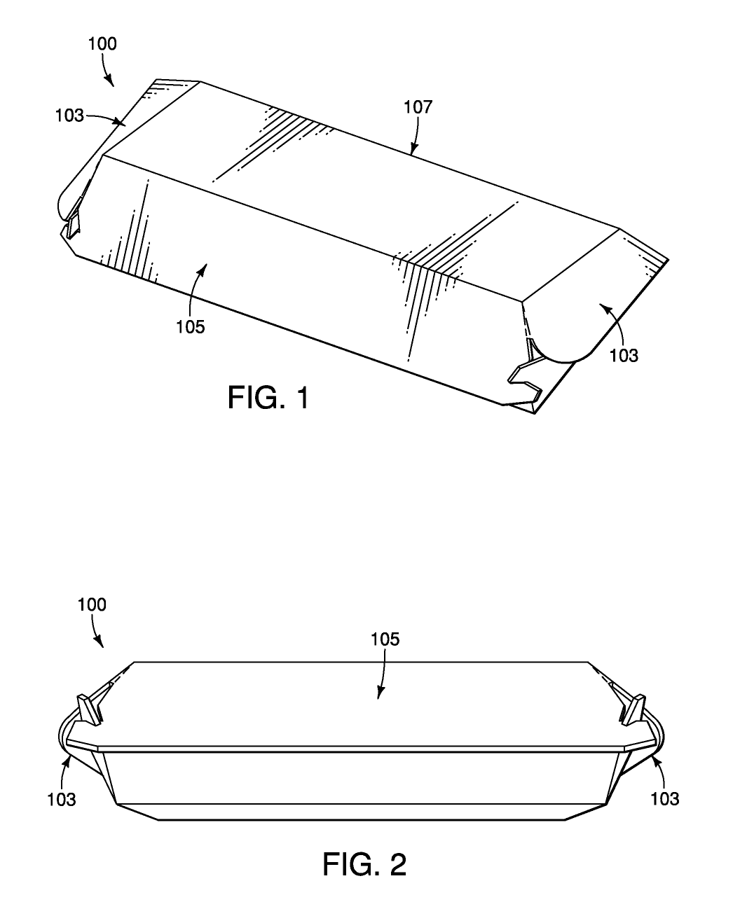

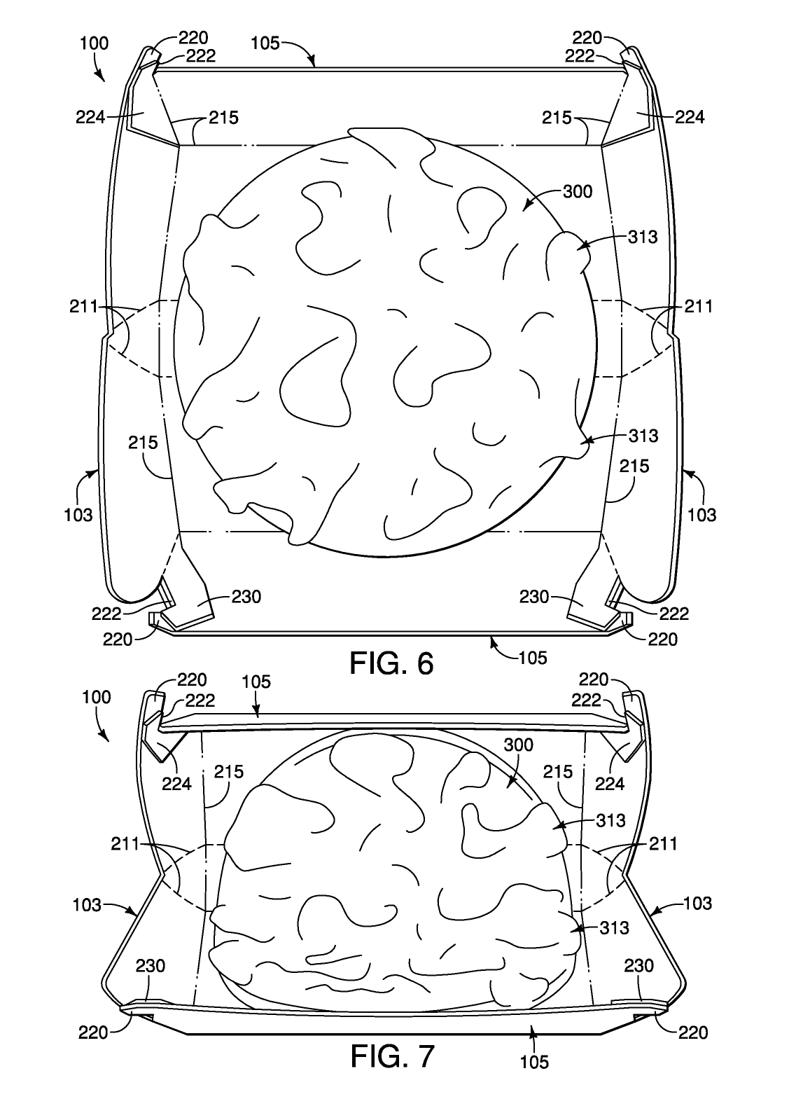

FIGS. 1 and 2 respectively show side and top perspective views of an exemplary flatbread container 100, after full assembly with a food item therein (shown in FIGS. 6 and 7). The container 100 may include end (or side) portions 103, a top portion 105, and a bottom portion 107. The food item may be a flatbread, flour or corn tortilla, or other flexible food item. The flatbread or tortilla may further be made into a flatbread sandwich, a wrap, or a soft taco or the like after adding various toppings and/or sauces to the top of the flatbread or tortilla. Other food products are envisioned and, therefore, the above-listed food items are mentioned as exemplary and are not meant as limiting.

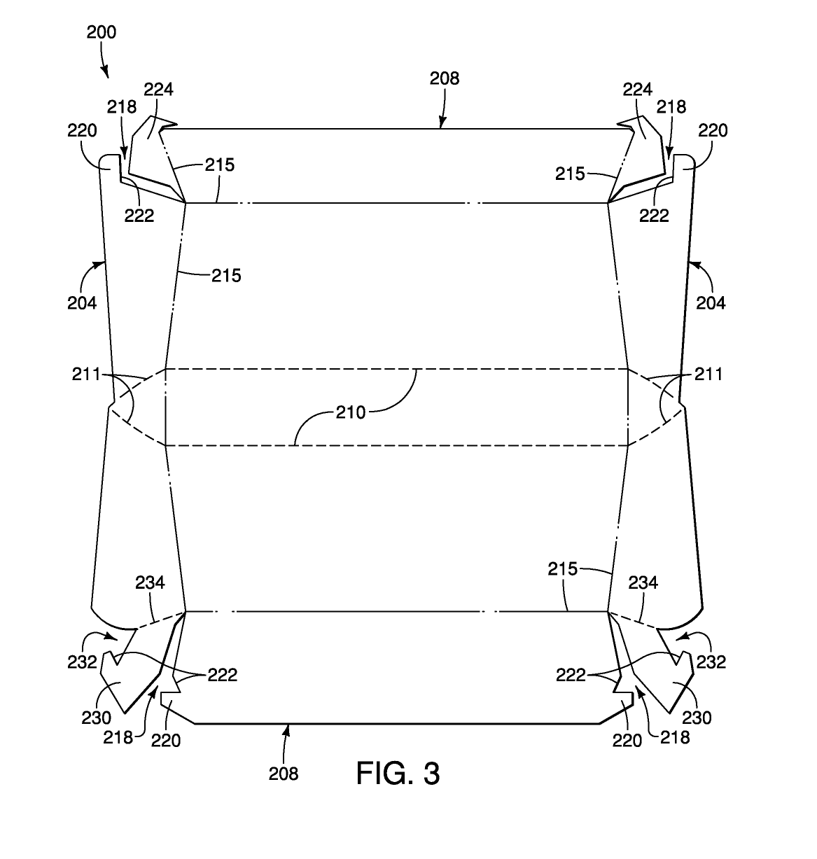

FIG. 3 is a top, plan view of an exemplary paperboard flat blank 200 before assembly into the flatbread container 100. The flat blank 200 is formed from paperboard and is a single piece of the paperboard after having been cut out of the manufactured paperboard. The flat blank 200 may be formed in a substantially rectangular shape having four sides, generally two first sides 204 and two second sides 208. The flat blank 200 includes a pair of perforated lines 210 that run generally in the middle of the flat blank 200 between the two first sides 204 to facilitate folding the flat blank 200 in half along the perforated lines, and thus forming the bottom portion 107 of the container 100. The perforated lines 210 may include more or less than a pair and may run generally parallel. The perforated lines 210 may come together at an angle at end portions 211 of the perforated lines 210 toward the edges of the first sides 204 to facilitate closing the end (or side) portions 103 around a food item placed thereon. The end portions 211 of the perforated lines 210 may come to a point at the edges of the first sides 204.

The flat blank 200 may also include scored lines 215 spaced from the edges of both the first sides 204 and the second sides 208. The scored lines 215 spaced from edges of the first sides 204 facilitate folding to form the end (or side) portions 103 of the container 100 while the scored lines 215 spaced from edges of the second sides 208 facilitate folding to form the top portion 105 of the container 100. The scored lines 215 spaced from edges of the first sides 204 may cross the pair of perforated lines 210 about where the perforated lines 210 begin to come together to meet at the edges of the first sides 204. This provides a triangular meeting point in the end (or side) portions 103 of the container 100 that easily collapses the end portions 103 during assembly around the food item.

The flat blank 200 may also include diagonal slots 218 formed or cut from corners of the flat blank 200. The diagonal slots 218 may define a number of hook structures 220 having notches 222, examples of which are shown in FIG. 3. Any sort of hook structures may be formed for the purpose of mutual engagement of the hook structures to secure the second sides 208 closed at the end of full assembly of the container 100.

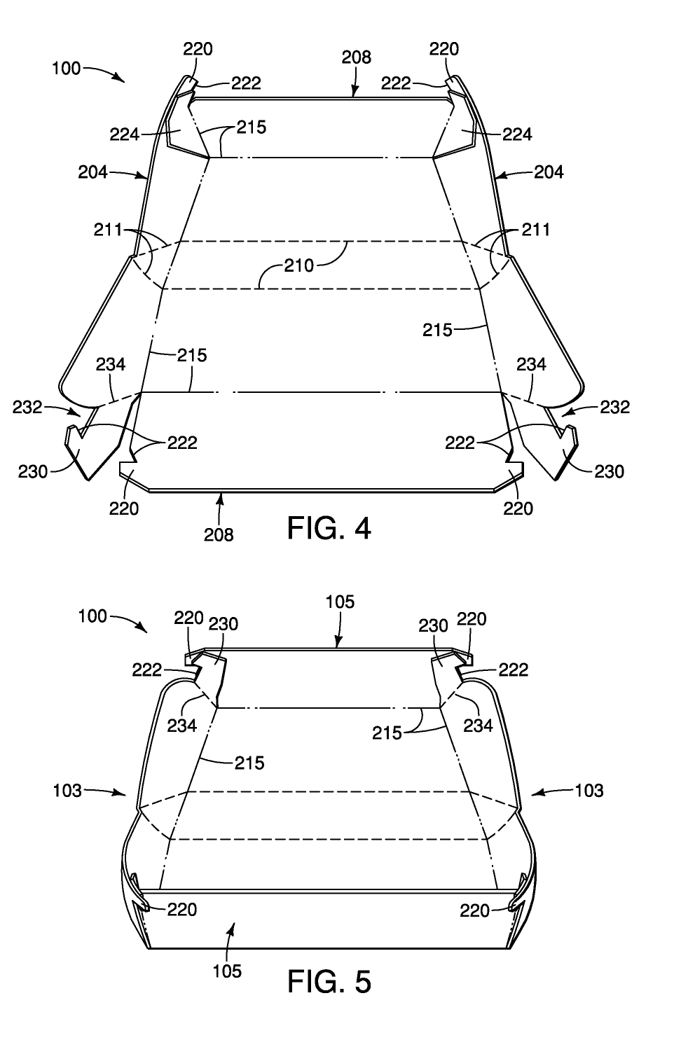

In one example, one or more corners include tabs 224 corresponding to the diagonal slots 218 and opposite from the hook structures 220. The tab 224 of each corner may be glued to the inside of the end portion 103 opposite the tab 224 as shown in FIG. 4. While not shown this way in drawings, the tab and hook structure may also be switched in orientation and thus the tab 224 may be glued to the inside of the top portion 105 of the container 100 in another example. In this additional example, because of the switch in orientation, the hook structure 220 may be formed in the corner of the second sides 208. When the tab 224 is glued to the inside of the top or end portion of the container 100, the opposing hook structure 220 may protrude to the outside of the container 100 as shown in FIG. 4. Simultaneously, the folding of the scored lines 215 of the container 210, including scored lines 215 at the base of each tab 224, will also help each tab 224 to bend and be put into place for gluing.

In yet another example, a second hook structure 230 may be formed to the outside of the hook structures 220 in one or more corners of the container 100. The second hook structures 230 may be formed on the other side of the diagonal slots 218 from the first hook structures 220 and may be formed from notched sections 232 cut out of the flat blank 200. Furthermore, the second hook structures 230 may be formed so that the notches 222 of the first and second hook structures 220 and 230 mutually align to enable gluing each second hook structure 230 onto the top of corresponding first hook structures 220 as shown in FIG. 5. Each second hook structure 230 may have a perforated line 234 formed at its base to facilitate folding the second hook structures 230 onto the first hook structures 220. Simultaneously, the folding of the scored lines 215 of the container 210 will also help the proper mutual alignment of the first and second hook structures 220 and 230.

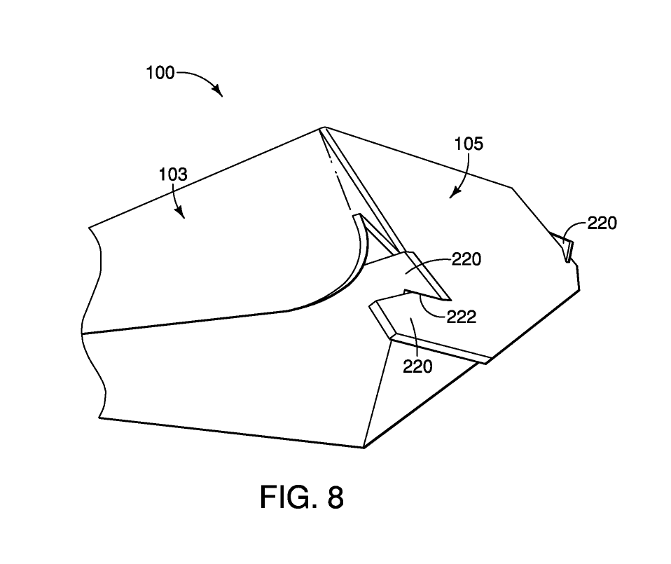

As displayed in FIGS. 1 and 2 and FIGS. 4 and 5, the hook structures 220 and 230 and tabs 224 may be formed such that opposing hook structures 220 on opposite second sides 208 of the container 204 each have an opposite orientation to each other to facilitate mutual engagement and securing closed the second sides 208 of the container 100 when squeezed shut. More specifically, the notches that form the hook structures 220 should engage in mutual opposition between the second sides 208 of the container 100. This opposite orientation and mutual engagement of the hook structures 220 and 230 is seen in FIGS. 1, 2, and 7 and most clearly in FIG. 8. The flat blank 200 may include any combination of the hook structures 220 and 230 and the tabs 224 and any other hook-like structure in the various corners of the flat blank 200.

During the manufacturing process, the paperboard flat blanks 200 are made from paperboard sheet material that moves along a conveyor belt system. The paperboard sheet material may correspond to a corrugated paper material or a different material suitably rigid for storing food items. A microfluted sheet material such as an F-fluted sheet material may be utilized to improve heat retention of the container 100. The paperboard sheet material may be made from or include cardboard, foam, cellulosic fiber, wood, white virgin paper, brown recycled paper, or other materials and may be biodegradable, recyclable or compostable or otherwise adapted to environmental sustainability.

Accordingly, the sheet material may first be corrugated and optionally laminated during initial steps of manufacturing. After preparation of the corrugated sheet material, the paper blanks 200 are cut into the paperboard sheet material such as with a die patterned to form the shape of the paper blanks 200. After the flat blanks 200 are cut, they are conveyed for further processing, including removal of the blanks from the sheet material. The corners are then glued as discussed with reference to FIGS. 4 and 5 before being stacked and prepared for shipment. The corners may be glued at a station of the conveyor system or may be glued by hand.

With reference to FIGS. 6 and 7, to finish assembly of a food product using the container 100, a food preparer places a food item such as a flatbread 300 in the center of the partially-assembled container 100 as it lies flat. As mentioned, the flatbread may also be a tortilla or some other flat, flexible food item. The food preparer may then place a number of toppings 313 on the flatbread 300 to complete a sandwich, wrap, or taco. Then, the food preparer may squeeze the partially-assembled container 100 together with the prepared food item(s) 300 and 313 so that it folds in half along the perforated lines 210 as shown in FIG. 7. Simultaneously, the end portions 103 are formed as the first sides 204 of the container 100 fold about the end portions 211 of the perforated lines 210 and fold about the scored lines 215 spaced from the edges of the first sides 204. The top portion 105 of the container 100 is formed as the second sides 208 are brought together and the hook structures 220 and 230 mutually engage to secure the container 100 shut. The finished food product within the fully assembled container 100 may be served to another satisfied customer.

While various embodiments of the invention have been described, it will be apparent to those of ordinary skill in the art that many more embodiments and implementations are possible that are within the scope of the invention. For instance, steps of a method as displayed in the figures or reflected in the below claims do require a specific order of execution by the way they are presented, unless specified. The disclosed steps are listed as exemplary such that additional or different steps may be executed or the steps may be executed in a different order.

1. A container made out of a single, flat piece of paperboard having four sides and a pair of perforated lines formed therein running between two first sides and generally in the middle of the paperboard, the pair of perforated lines coming together at end portions thereof to meet at edges of the first sides to facilitate folding the flat paperboard in half along the perforated lines to close the container around a food item placed thereon.

2. The container of claim 1, where the first sides include scored lines that cross the pair of perforated lines substantially where the perforated lines begin to come together and that define end portions of the container when folded, and where the second sides include scored lines spaced from an edge thereof that define top portions of the container when folded.

3. The container of claim 2, the flat paperboard including corners forming diagonal slots substantially to the scored lines of the second sides, the corners also defining hook structures for mutual engagement thereof between two second sides of the container when the container is folded in half along the at least one perforated line.

4. The container of claim 3, where the hook structures on opposing corners of the two second sides are formed in opposition to each other, one facing in and the other facing out, to enable the mutual engagement thereof.

5. The container of claim 4, where the hook structures are first hook structures and the diagonal slots are first diagonal slots, where in each of the corners of at least one of the second sides is formed a second diagonal slot defining a second hook structure, the first and second hook structures having notches that mutually align when the end portions are folded along the scored lines of the first sides and the top portions are folded along the scored lines of the second sides, thereby allowing the first and second hook structures to be glued to each other.

6. The container of claim 5, where the corners of the at least one of the second sides are perforated between the first and second diagonal slots to help the mutual alignment of the first and second hook structures.

7. The container of claim 4, where in the corners of at least one of the second sides are formed tabs corresponding to the diagonal slots and opposite from the hook structures, thereby allowing the tabs to be glued to the inside of the end or top portion adjacent thereto while allowing the hook structures to protrude when the end portions are folded along the scored lines of the first sides and the top portions are folded along the scored lines of the second sides.

8. A paperboard flat blank, scored for folding to form a flatbread container, the flat blank comprising:
two first sides and two second sides defining a generally-rectangular shape; and
a pair of generally-parallel perforated lines formed running between the first sides generally in the middle of the flat blank, the pair of perforated lines angling toward each other at end portions thereof to form a point at edges of the first sides to facilitate folding the container in half along the perforated lines to close the container around a flatbread placed thereon;
where the first sides include scored lines that define closed side portions of the container when folded, the scored lines crossing the perforated lines substantially where the perforated lines begin to angle together, and where the second sides include scored lines spaced from edges thereof that define closed top portions of the container when folded.

9. The flat blank of claim 8, further comprising:
diagonal slots formed in corners of the flat blank that define at least one first hook structure in each corner, the first hook structures positioned for mutual engagement when the flat blank is folded in half along the perforated lines.

10. The flat blank of claim 9, where in each of two corners of the flat blank is formed a notched cutout forming a second hook structure, the first and second hook structures having notches that mutually align when the side portions are folded along the scored lines of the first sides and the top portions are folded along the scored lines of the second sides, thereby allowing the first and second hook structures to be glued to each other with their notches substantially aligned.

11. The flat blank of claim 10, where the corners having the first and second hook structures include a perforated line at a base of the second hook structure to help the mutual alignment of the first and second hook structures during folding.

12. The flat blank of claim 10, where in each of the other two corners are formed tabs corresponding to the diagonal slots and opposite from the first hook structures, the tabs positioned and scored to facilitate gluing thereof to the inside of the side or top portion adjacent thereto while allowing the first hook structures to protrude when the side portions are folded along the scored lines of the first sides and the top portions are folded along the scored lines of the second sides.

13. The flat blank of claim 12, where the corners having the first and second hook structures oppose the corners having the tabs.

14. A method for forming paperboard flat blanks for making flatbread containers, the flat blanks including two first sides and two second sides defining a generally-rectangular shape, the method comprising, in each flat blank:
forming a pair of perforated lines running between the first sides of the flat blank generally in the middle of the flat blank, the pair of perforated lines coming together at end portions thereof to meet at edges of the first sides to facilitate folding a container in half along the perforated lines to close the container around a flatbread placed thereon;
forming scored lines near the first sides of the flat blank to provide a fold for side portions of the container, the scored lines crossing the perforated lines substantially where the perforated lines start to come to together; and
forming scored lines spaced from edges of the second sides of the flat blank to provide a fold for top portions of the container.

15. The method of claim 14, further comprising:
cutting diagonal slots in each of the corners of the flat blank that define first hook structures at outer portions of the corners for mutual engagement of the first hook structures between the two second sides when the flat blank is folded along the perforated lines to form the flatbread container;
cutting out a notched section in at least two corners of the flat blank to the outside of the diagonal slots, the notched section forming second hook structures, the first and second hook structures having notches that mutually align when the side portions are folded along the scored lines of the first sides and the top portions are folded along the scored lines of the second sides; and
forming a perforated line at a base of the second hook structures to facilitate the mutual alignment of the first and second hook structures during folding.

16. The method of claim 15, further comprising:
forming tabs in the remainder of the corners not having second hook structures, the tabs positioned and scored to facilitate gluing thereof to the inside of the side or top portion adjacent thereto while allowing the first hook structures to protrude when the side portions are folded along the scored lines of the first sides and the top portions are folded along the scored lines of the second sides; and
removing the flat blanks from a paperboard sheet to be formed into containers.

17. The method of claim 16, where the corners having the first and second hook structures comprise two corners opposite corners having the tabs.

18. A method of using a generally-rectangular paperboard flat blank as a flatbread container, the flat blank having a pair of perforated lines formed running between first sides thereof generally in the middle of the flat blank, the pair of perforated lines coming together at end portions thereof to meet at edges of the first sides to facilitate folding the container in half along the perforated lines, where the first sides include scored lines that define side portions of the container when folded, the scored lines crossing the perforated lines substantially where the perforated lines begin to come together, and where the second sides include scored lines spaced from edges thereof that define top portions of the container when folded, the method comprising:
laying the flat blank on a surface;
placing a flatbread in the center of the flat blank;
placing toppings on top of the flatbread;
folding the flat blank, along with the flatbread and toppings atop thereof, along the pair of perforated lines; and
closing the container by folding along the scored lines of the first and second sides to form the side and top portions that enclose the flatbread and toppings within the container.

19. The method of claim 18, where the flat blank includes diagonal slots formed in corners thereof that define first hook structures, the first hook structures positioned for mutual engagement between two second sides thereof when the flat blank is folded in half along the perforated lines, the method further comprising:
connecting the opposing first hook structures to each other to secure the second sides shut.

20. The method of claim 19, where two of the corners of the flatbread include a cutout portion that forms a second hook structure, the first and second hook structures positioned and scored to mutually align on top of each other, and where the other two corners include scored tabs corresponding to the diagonal slots and opposite from the first hook structures, the method further comprising:
gluing the second hook structures on top of the first hook structures in corners having the second hook structures so that their notches substantially align;
gluing the tabs in the corners having tabs to the inside of the side or top portion adjacent to the tabs such that the first hook structures protrude; and engaging the protruding hooks with the first and second glued hook structures of opposing corners.
